(19) United States
(12) Patent Application Publication
(10) Pub. No.: US 2017/0175961 A1
(43) Pub. Date: Jun. 22, 2017

(54) LIGHTING SYSTEM HAVING STRUCTURAL COMPONENTS WITH INTEGRATED LIGHTING

(71) Applicant: Applied Electronic Materials, LLC, Fort Wayne, IN (US)

(72) Inventor: Tom Martin, Fort Wayne, IN (US)

(21) Appl. No.: 15/382,091

(22) Filed: Dec. 16, 2016

Related U.S. Application Data
(60) Provisional application No. 62/269,466, filed on Dec. 18, 2015.
(60) Provisional application No. 62/363,715, filed on Jul. 18, 2016.

(51) Int. Cl. F21S 8/04; F21V 23/06; F21S 4/28; B05D 7/00; F21V 29/74; F21V 19/00; B05D 3/02; B05D 1/28; F21V 29/89; F21V 21/005

(52) U.S. Cl. CPC F21S 8/04; F21V 29/89; F21V 23/06; F21S 4/28; F21V 21/005; F21V 29/74; F21V 19/003; B05D 3/0254; B05D 1/28; B05D 7/544; F21Y 2115/10

(57) ABSTRACT

Lighting systems are provided for use in building interiors or for exterior lighting. The lighting systems include a light module formed of a heat conductive structural substrate, together with a lighting configuration formed directly on an exposed surface of the substrate via thick film printing techniques. The substrate is a highly heat conductive material such aluminum or aluminum alloy, and includes an electrically insulating layer printed and cured directly on an exposed surface of the substrate, a circuit layer printed and cured directly on the insulating layer, and a plurality of LEDs electrically attached to the circuit layer. In this manner, each light module is formed as a single-component, packaged construct for easy installation, and facilitates conductive transfer of heat away from the LEDs for enhanced power efficiency. The ceiling modules provide electrical and mechanical connectivity to form a self-supporting, integrated ceiling grid.

### CROSS REFERENCE TO RELATED APPLICATIONS

This application claims the benefit under Title 35, U.S.C. §119(e) of U.S. Provisional Patent Application Ser. No. 62/269,466, entitled LIGHTING SYSTEM HAVING STRUCTURAL COMPONENTS WITH INTEGRATED LIGHTING, filed on Dec. 18, 2015, and U.S. Provisional Patent Application Ser. No. 62/363,715, entitled LIGHTING SYSTEM HAVING STRUCTURAL COMPONENTS WITH INTEGRATED LIGHTING, filed on Jul. 18, 2016, and the disclosures of each are expressly incorporated herein by reference.

### BACKGROUND

1. Field of the Disclosure

The present disclosure relates to lighting systems, such as those used in building interiors or for exterior lighting, for example. In one embodiment, the present disclosure relates to a lighting system including structural components, such as components of a ceiling grid structure, with integrated lighting.

2. Description of the Related Art

Interior building spaces, particularly commercial or working spaces, are often provided with a suspended or “drop” ceiling which is formed by a grid of structural components that are connected to one another and suspended at a desired height below a permanent, structural ceiling. The structural grid is often made of connected metallic components, with ceiling tiles disposed within the grid spaces between the structural components. The ceiling tiles together provide a heat insulating layer to separate the space above the suspended ceiling from the working space below, wherein the space above the ceiling is often subjected to undesirably hot or cool temperatures as opposed to the temperatures in the working space, which are more closely controlled by the HVAC system of the building.

One typical lighting arrangement involves the use of fluorescent light modules, which are connected to the grid structure and disposed in spaces between the ceiling tiles. Another typical arrangement involves the use of light emitting diode (LED) modules, which may also be connected to the grid structure and disposed in spaces between ceiling tiles.

In still another arrangement, LED modules that include separate structural housings containing LED components and their associated control circuitry may be attached directly to the grid members via a mechanical connection, in which the LED modules are disposed in-line with the grid structure itself between the edges of the suspended ceiling tiles. One advantage of this configuration is that the ceiling grid structures themselves may function to conductively convey heat away from the LED modules into the space above the suspended ceiling. However, a disadvantage of this configuration is that the LED modules are manufactured separately from the grid structures and therefore are typically expensive to purchase and install. Also, heat removal from the LED modules may be inefficient, compromising the electrical efficiently of the LED modules. Further, the LED modules may be somewhat large and bulky in size, contributing to an increased overall visual exposure of the grid structure.

What is needed is an improvement over the forgoing.

### SUMMARY

The present disclosure relates to lighting systems for use in building interiors or for exterior lighting. The lighting systems include a light module formed of a heat conductive structural substrate, together with a lighting configuration formed directly on an exposed surface of the substrate via thick film printing techniques. The substrate is a highly heat conductive material such aluminum or aluminum alloy, and includes an electrically insulating layer printed and cured directly on an exposed surface of the substrate, a circuit layer printed and cured directly on the insulating layer, and a plurality of LEDs electrically attached to the circuit layer. In this manner, each light module is formed as a single-component, packaged construct for easy installation, and facilitates conductive transfer of heat away from the LEDs for enhanced power efficiency. The ceiling modules provide electrical and mechanical connectivity to form a self-supporting, integrated ceiling grid.

In one form thereof, the present disclosure provides a light module, including a substrate made of a metallic, heat conductive material, including a deposition surface; an electrically insulating layer deposited on the deposition surface; an electrically conductive circuit layer deposited on the insulating layer and including a plurality of metallic circuit traces; and a plurality of LED units electrically connected to the circuit layer.

In another form thereof, the present disclosure provides a method of manufacturing a light module, including the following steps: providing a substrate made of a metallic, heat conductive material and having an exposed deposition surface; applying an electrically insulating layer composition onto the deposition surface via a thick film deposition process; heat curing the electrically insulating layer composition to form an electrically insulating layer; applying an electrically conductive circuit layer composition on the insulating layer via a thick film deposition process; heat curing the electrically conductive circuit layer composition to form an electrically conductive circuit layer; and attaching a plurality of LED units to the circuit layer.

In a further form thereof, the present disclosure provides a ceiling grid system including a ceiling module, the ceiling module including: an elongate structural support; an elongate light module separate from, and removably connectable to, the structural support, the light module made of a metallic, heat conductive material and including: a deposition surface; an electrically insulating layer deposited on the deposition surface; an electrically conductive circuit layer deposited on the insulating layer and including a plurality of metallic circuit traces; and a plurality of LED units attached to the circuit layer.

### BRIEF DESCRIPTION OF THE DRAWINGS

The above-mentioned and other features of the disclosure, and the manner of attaining them, will become more apparent and will be better understood by reference to the following description of embodiments of the disclosure taken in conjunction with the accompanying drawings, wherein:

FIG. 1 is a schematic perspective view showing a ceiling grid system including a ceiling module in accordance with the present disclosure;

FIG. 2A is an end view of a ceiling module, further showing a portion of a ceiling tile supported by the ceiling module;

FIG. 2B is an end view of a ceiling module according to another embodiment;

FIG. 3 is a sectional view taken along line 3-3 of FIG. 1;

FIG. 4 is a sectional view taken along line 4-4 of FIG. 1;

FIG. 5A is a sectional view similar to FIG. 3, showing a first light module configuration;

FIG. 5B is a sectional view similar to FIG. 3, showing a second light module configuration;

FIG. 6 is partial perspective view of a ceiling module together with a connector module;

FIG. 7 is a perspective view of another connector module; and

FIG. 8 is a partial perspective view of a ceiling module and a power in-feed connector module, further showing power input circuitry.

Corresponding reference characters indicate corresponding parts throughout the several views. The exemplifications set out herein illustrate embodiments of the disclosure and such exemplifications are not to be construed as limiting the scope of the disclosure in any manner.

### DETAILED DESCRIPTION

Although the present disclosure has been described in detail herein in connection with an exemplary embodiment of a light module for use as a component of a ceiling grid system for a building interior, the teachings of the present disclosure are more broadly applicable for light modules in general, including both interior and exterior lighting systems, in which thick film techniques are employed to provide layers directly onto a heat conductive substrate which forms a foundational substrate or structural component of the light module.

For example, light modules made according to the teachings herein could be used for high-volume lighting applications of the type in which a large number of LEDs are provided on circuit layers deposited over electrically insulating layers which are in turn deposited over heat conductive substrates of light modules. These light modules may be combined with a large number of like light modules into banks of light modules which are capable of use with other banks of light modules to light large interior spaces, such as stadiums, convention centers, warehouses, or factory spaces, for example. In other embodiments, light modules constructed in accordance with present teachings may be used for exterior lighting such as flood lights, display signs, street lights, or traffic or other signaling lights, or in mobile applications such as automotive or other vehicular lighting.

Referring to FIG. 1, in an exemplary application of the present disclosure, a ceiling grid system 10 is shown, which includes a plurality of individual ceiling modules 12 made in accordance with the present disclosure. Ceiling grid system 10 may be used in a building interior, for example, to separate an upper, utility space 14 above ceiling grid system 10 from a lower, occupied working space 16 which is more closely controlled by the HVAC system of the building.

Ceiling module 12 may be formed of an extruded or sheet stock metallic component having a substantially uniform cross section and high heat conductivity, such as aluminum or an aluminum alloy, such as 3000, 4000, 5000 and 6000 series aluminum alloys, which typically have a thermal conductivity over 150 W/m-K. Other, less heat conductive, metals and metal alloys include low carbon steel and stainless steel. Advantageously, aluminum or aluminum alloys combine the desired features of high heat conductivity with high strength, while also being sufficiently lightweight for use in a ceiling grid system or similar application requiring lightweight structural components. In one embodiment, ceiling module 12 may have a length of as little as 6 inches, 12 inches, 18 inches, or as great as 24 inches, 36 inches, 48 inches or greater, or within any range defined between any two of the foregoing values, such as may be needed for complying with any applicable standard constructions.

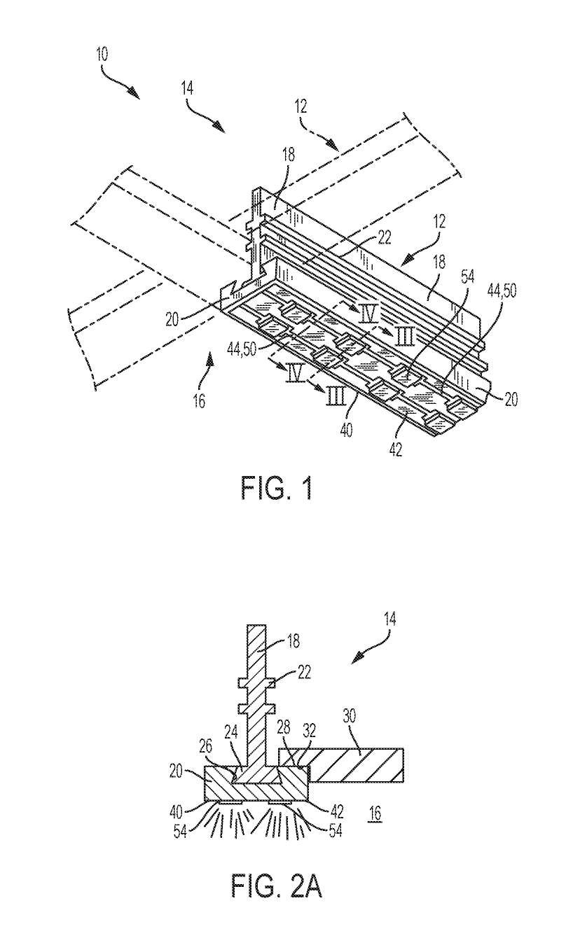

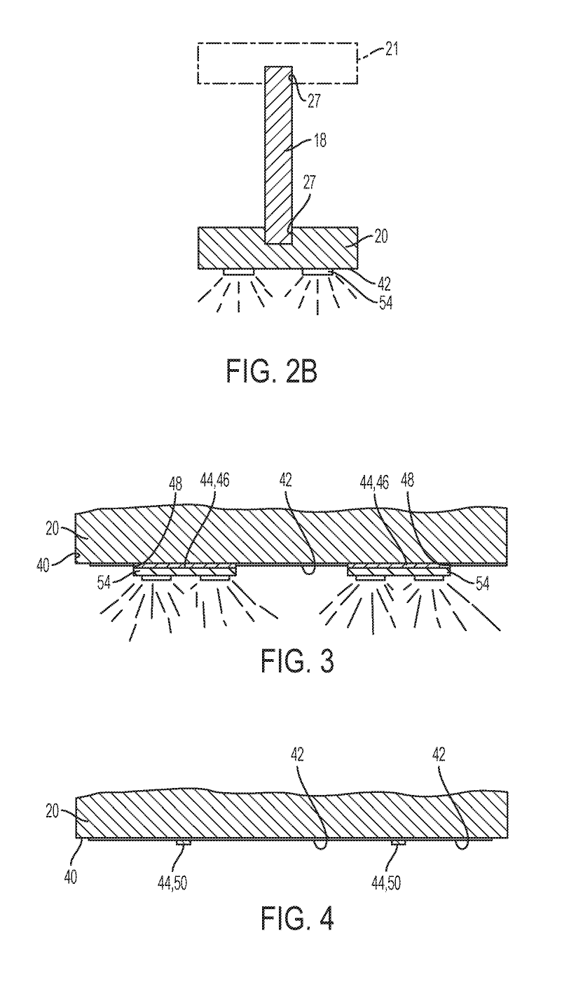

Referring additionally to FIG. 2A, ceiling module 12 may advantageously be formed as a two-part structure including an elongate structural support 18 and an elongate light module 20 which is separate from, and removably connectable to, structural support 18. Structural support 18 and light module 20 may each be formed of the same or different heat conductive metals or metal alloys such as those identified above, and both generally function to provide structural support for the lighting assembly described below. In another embodiment, structural support 18 and light module 20 may be monolithically or integrally formed of the same extrusion though, for the reasons discussed below, it may be preferable for the forgoing components to be formed separately from one another for manufacturing purposes.

Structural support 18 and light module 20 form the structural component of a ceiling grid, and may be attached to other like components in a suitable manner using mechanical fasteners (not shown) or the connector modules described below, for example, to form a structural grid arrangement which is suspended from a permanent, structural ceiling in a building environment, i.e., is the structural grid component of ceiling grid system 10 of FIG. 1, in which additional like structural supports are shown schematically in dashed lines. Structural support 18 and/or light module 20 may also include one or more heat dissipation projections or fins 22 monolithically or integrally formed therewith, which extend from the main body of structural support 18 to increase the available surface area of structural support 18 available for heat dissipation into utility space 14 via convection.

Referring to FIG. 2A, structural support 18 may include a first connector structure, and light module 20 may include a cooperating second connector structure connectable to the first connector structure. In one embodiment, the first connector structure is formed as a projection 24 and the second connector structure is formed as a channel 26. For example, projection 24 may extend from structural support 18, and may be shaped as a dovetail-type projection slidably receivable within a dovetail-type channel formed in light module 20. Alternatively, the foregoing arrangement may be reversed, in which structural support 18 includes channel 26 and light module 20 includes projection 24. In this manner, light module 20 may be attached to structural support 18 by a longitudinal sliding engagement between the forgoing components prior to ceiling module 12 being installed as part of the ceiling grid system 10. In one embodiment, the forgoing connection may be configured as a close mechanical fit by which light module 20 is frictionally engaged with structural support 18 to facilitate the efficient conduction of heat between the forgoing components by direct contact. If desired, suitable thermal interface materials, such as heat conductive pastes or greases, may be applied between the forgoing components to promote an even more efficient conduction of heat.

Still referring to FIG. 2A, light module 20 may include an upper surface forming a shelf 28 for supporting one or more ceiling tiles 30 in the ceiling grid system 10 wherein, for example, each ceiling tile 30 may include a notched edge 32 for receipt on shelf 28 of light module 20. If ceiling tile 30 is made of a heat insulating material, heat from light module 20 may be transferred effectively directly from light module 20 to structural support 18 via conductive contact as opposed to tile 30, for subsequent dissipation from structural support 18 via convection within utility space 14 above ceiling tiles 30 of ceiling grid system 10.

Referring to FIG. 2B, alternative cross-sectional shapes of structural support 18 and light module 20 are shown according to another embodiment. Structural support 18 and light module 20 may each be cut lengths of metallic sheet stock material having rectangular cross sections, with a channel 27 machined along a broad side of the length of light module 20. An end side of structural support 18 may be fitted, such as via an interference fit, within channel 27. Optionally, a further structural member 21, analogous to light module 20 in shape but lacking the lighting elements described below, may be fitted to the upper end of structural support 18 to form an I-beam type construction for ceiling module 12 to provide increased structural support and/or increased mass for conductive receipt of heat from the lighting elements.

According to the present disclosure, and referring to FIGS. 1-4, light module 20 includes an exposed deposition surface 40 upon which a lighting configuration is directly deposited via a thick film application method, as described in detail below. For example, if light module 20 is made of aluminum or aluminum alloy, deposition surface is the exposed aluminum or aluminum alloy surface of light module 20.

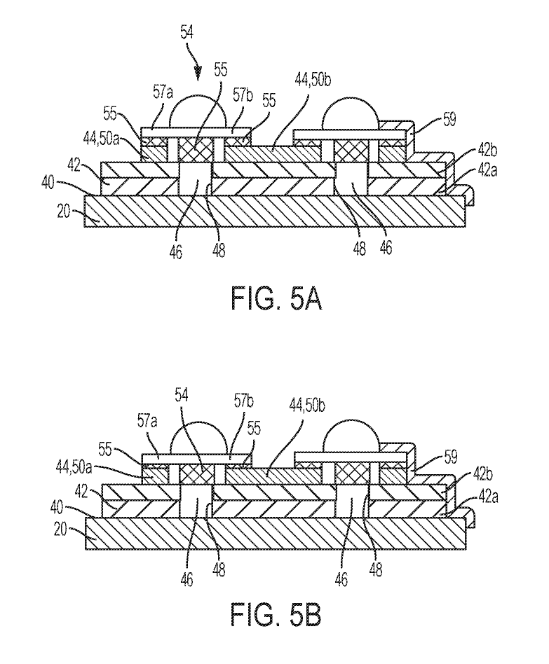

FIGS. 5A and 5B illustrate exemplary layered structures in accordance with the present invention, as described in detail below, though these figures are schematic and are not drawn to scale in connection with the thicknesses of the layers of the structures.

A first exemplary light module configuration and thick film application process is described below with primary reference to FIG. 5A, by which layers and components of a lighting configuration may be applied directly to deposition surface 40 of light module 20. In a first step, one or more dielectric or electrically insulating layers 42 are deposited directly onto deposition surface 40 of light module 20 via a thick film coating technique such as screen printing. The composition of insulating layer 42 may be provided in the form of a viscous liquid or paste which generally includes at least one polymer resin, inorganic particles, a glass phase, and at least one organic carrier liquid or solvent.

Generally, the insulating layer 42 functions to electrically insulate the material of light module 20 from a circuit layer 44 which is subsequently deposited on insulating layer 42, though in some embodiments, insulating layer 42 may also be heat conductive and sufficiently thin to facilitate heat conduction from the LED units through insulating layer 42 into the material of light module 20 as may be necessary. In other embodiments, as described below, openings are formed in insulating layer 42 which may be filled with a deposited metallic layer to form thermal vias through insulating layer 42 for direct conductive transfer of heat from the LED units to light module 20.

In the pre-cured composition of insulating layer 42, the polymeric resin provides a binder or carrier matrix for the inorganic particles, and also provides adhesion of the composition to the underlying substrate prior to the heat cure step in which the polymeric resin is removed. The inorganic particles form the bulk material of insulating layer 42 and also function to conduct heat through insulating layer 42. The organic carrier liquid provides a removable carrier medium to facilitate application of insulating layer 42 prior to heat cure, and is removed upon heat cure. The pre-cured composition of insulating layer 42 may also include other additives, such as surfactants, stabilizer, dispersants, as well as one or more thixotropic agents such as hydrogenated castor oil, for example, to increase the viscosity as necessary in order to form a paste.

The polymer resin may be an epoxy resin, ethyl cellulose, ethyl hydroxyethyl cellulose, wood rosin, phenolic resins, polymethacrylates of lower alcohols, or mixtures of the foregoing.

The inorganic particles may be oxides such as aluminum oxide, calcium oxide, nickel oxide, silicon dioxide, or zinc oxide, for example, and/or other inorganic particles such as aluminum nitride, beryllium oxide, and may have a particle size of as little as 1 micron, 3 microns, 5 microns, or as great as 7 microns, 9 microns, or 12 microns, or may have a size within any range defined between any two of the foregoing values. Advantageously, the use of aluminum-containing dielectric inorganic materials in insulating layer 42 may provide a favorable coefficient of thermal expansion (CTE) match with the underlying aluminum or aluminum alloy substrate of light module 20 for enhanced thermal cycling durability and consequent physical longevity.

The inorganic portion of the composition may also include a glass phase, such as a borosilicate glass frit, which provides a matrix for the inorganic particles, facilitates sintering during the heat cure step at temperatures below the melting point of the substrate, and also provides adhesion of the composition to the underlying substrate following the heat cure step.

Suitable solvents may include relatively high boiling solvents having a boiling point of 125° C. or greater, which evolve at a slower rate than relatively lower boiling point solvents in order to provide a sufficiently long dwell time of the composition on the screen during the printing process. Examples of relatively high boiling point solvents include ethylene glycol, propylene glycol, di(ethylene)glycol, tri(ethylene)glycol, tetra(ethylene)glycol, penta(ethylene)glycol, di(propylene)glycol, hexa(ethylene)glycol, di(propylene)glycol methyl ether, as well as alkyl ethers of any of the foregoing and mixtures of the foregoing.

In the composition of insulation layer 42, the inorganic content is typically as low as 45 wt. %, 50 wt. %, or 55 wt. % or as great as 70 wt. %, 75 wt. %, or 80 wt. % of the total composition, or may be present within any range defined between any two of the foregoing values, and the organic content is typically as low as 20 wt. %, 25 wt. %, or 30 wt. %, or as great as 45 wt. %, 50 wt. % or 55 wt. % of the total composition, or may be present within any range defined between any two of the foregoing values. Of the inorganic content of the composition, the glass phase is typically present in an amount as low as 15 wt. %, 20 wt. %, or 25 wt. % or as great as 45 wt. %, 50 wt. %, or 55 wt. % of the total inorganic content, or may be present within any range defined between any two of the foregoing values, with the inorganic particles comprising the balance of the inorganic content of the composition. The solvent typically comprises as low as 65 wt. %, 70 wt. %, or 75 wt. % or as great as 85 wt. %, 90 wt. %, or 95 wt. % of the total organic content of the composition, or may be present within any range defined between any two of the foregoing values.

The composition of insulating layer 42 may be applied via a screen printing process directly through a screen or stencil (not shown) directly onto deposition surface 40, optionally followed by an initial drying step, either at ambient or elevated temperature, in which some of the volatile components of the composition are evaporated. In a subsequent step after initial application followed by optional drying, insulating layer 42 may be heat cured in a furnace, such as a belt furnace, by heating insulating layer 42 to a desired elevated curing temperature to drive off any remaining volatile components, leaving the final layer in cured, solid form.

The curing temperature may be as low as 500° C., 550° C., or 600° C., of as high as 700° C., 750° C., or 800° C. or more, or within any range defined between any two of the foregoing values, and may be held at a dwell time of 2-45 min, for example. In one exemplary embodiment, the curing temperature may be from 550-600° C. at a dwell time of 2-30 min. The curing temperature should be below the melting point of the substrate.

One advantage of the two-piece construction of ceiling module 12 is that each light module 20 has a mass that is only a portion of the overall larger mass of a respective ceiling module 12 of which the light module 20 is a part. Thus, during the steps described herein by which insulating layer 42 and circuit layer 44 are applied to light module 20 and are then cured by heating, the overall mass of light module 20 is relatively small, such that light module 20 itself does not act as a sufficiently massive heat sink such that an excessive amount of heat is needed to elevate the applied temperature to properly cure the thick film layers that are applied to light module 20. However, once such thick film layers are applied and cured, light module 20, particularly when attached to structural support 18, may function as a portion of a larger heat sink with greater mass for purposes of more efficiently conducting heat away from the LED units attached to light module 20.

As desired, the forgoing process steps may be repeated to sequentially build insulating layer 42 to a desired final applied thickness. In one embodiment, insulating layer 42, after completion of a desired number of the foregoing application, drying, and heat curing steps, may be applied to a total film thickness of as little as 5 microns, 10 microns, 25 microns, or 50 microns, or as great as 100 microns, 250 microns, or 500 microns, or within any range defined between any two of the foregoing values. Also, multiple insulating layers 42 may be sequentially applied onto each other according to the above process to eliminate the probability of defects in the insulating layer 42, such as pinhole defects and/or the presence of debris. For example, in FIG. 5A, two discrete insulating layers 42a and 42b are shown, though more or less layers may be used as desired.

Referring to FIG. 5A, either before or after insulating layer 42 is applied, thermal vias 46 may be applied in the same manner, and using the same materials, as described below in connection with conductive circuit layer 44. In one embodiment, the application of thermal vias 46 onto deposition surface 40 of light module 20 via the thick film-based print and cure techniques described herein may be the initial step in forming the overall construction shown in FIG. 5A. In this embodiment, thermal vias 46 may be applied to deposition surface 40 of light module 20 at areas corresponding to gap spaces or openings 48 in the subsequently applied insulating layer 42, with thermal vias 46 direct contact with deposition surface 40 of light module 20. In another embodiment, thermal vias 46 may be applied within gap spaces or openings 48 of insulating layer 42 subsequently to the application of insulating layer 42 to deposition surface 40 of light module 20. The function of thermal vias 46 is described further below.

An electrically conductive circuit layer 44 may be deposited directly onto the insulation layer 42 via similar thick film techniques. The circuit layer 44 may be provided in the form of a viscous liquid or paste which generally includes conductive metal particles, at least one polymeric resin, and at least one organic carrier liquid or solvent. The composition of circuit layer 44 may also include a glass phase or metal oxide particles to promote adhesion of circuit layer 44 to the underlying insulating layer 42.

Generally, the circuit layer 44 functions to provide an electrically conductive circuit to provide power to the LED units, and is also itself heat conductive and sufficiently thin to facilitate heat conduction from the LED units to insulating layer 42 and thence into the material of light module 20. In the pre-cured composition of circuit layer, the conductive metal particles form the bulk of the final layer, and conduct electric current to the LED units. The polymeric resin provides a binder or carrier matrix for the conductive metal particles, and also provides adhesion of the composition to the underlying insulating layer 42 prior to the heat cure step in which the polymeric resin is removed. The organic carrier liquid provides a removable carrier medium to facilitate application of circuit layer 44 prior to heat cure, and is removed upon heat cure. The pre-cured composition of circuit layer 44 may also include other additives, such as surfactants, stabilizer, dispersants, as well as one or more thixotropic agents such as hydrogenated castor oil, for example, to increase the viscosity as necessary in order to form a paste.

The polymer resin may be an epoxy resin, ethyl cellulose, ethyl hydroxyethyl cellulose, wood rosin, phenolic resins, polymethacrylates of lower alcohols, or mixtures of the foregoing.

Suitable conductive metal particles include Ag, Cu, Zn, and Sn, or a mixture of the foregoing, wherein Ag is particularly suitable. The metal particles may also be alloys of the foregoing elements, such as Ag/Pt and Ag/Pd. The metal particles may be pure elemental metal, or may be in the form of metal derivatives such as oxides or salts, e.g., silver oxide (Ag₂O) or silver chloride (AgCl). Also, organometallic compounds may be used, such as metal methoxides, ethoxides, 2-ethylhexoxides, isobutoxides, isopropoxides, n-butoxides, and n-propoxides, for example. These metal particles may have a particle size of as little as 1 micron, 3 microns, 5 microns, or as great as 7 microns, 9 microns, or 12 microns, or may be within any size range defined between any two of the foregoing values.

Suitable organic carrier liquids or solvents include those listed above in connection with the composition of insulation layer 42, or mixtures of the foregoing.

In the composition of circuit layer 42, the metallic particles are typically present in an amount from as little as 45 wt. %, 50 wt. % or 55 wt. % to as great as 70 wt. %, 75 wt. % or 80 wt. % of the total composition, or may be present in an amount within any range defined between any two of the foregoing values. The glass phase or other metal oxide particles may be absent from the composition or, if included, may be present in an amount of as little as 1 wt. %, 3 wt. % or 5 wt. % or as great as 7 wt. %, 9 wt. % or 10 wt. % of the total composition, or may be present in an amount within any range defined between any two of the foregoing values. Typically, the solvent will comprise the primary component of the balance of the composition.

Similar to insulating layer 42, the circuit layer composition may be applied via a screen printing process directly through a screen or stencil directly onto insulation layer 42, optionally followed by an initial drying step, either at ambient or elevated temperature, in which some of the volatile components of the composition are evaporated. In a subsequent step after initial application followed by optional drying, circuit layer 44 may be heat cured in a furnace, such as a belt furnace, by heating circuit layer 44 to a desired elevated curing temperature to drive off any remaining volatile components, leaving the final layer in cured, solid form.

The curing temperature may be as low as 500° C., 550° C., or 600° C., or as high as 700° C., 750° C., or 800° C., or within any range defined between any two of the foregoing values, and may be held at a dwell time of 2-45 min. In exemplary embodiments, for a silver-based circuit layer, the curing temperature may be from 550-570° C. at a dwell time of 2-10 min., and for a copper-based circuit layer, the curing temperature may be from 550-600° C. at a dwell time of 5-7 min. The curing temperature should be below the melting point of the substrate.

Total thickness for circuit layer 44 following successive film builds by the foregoing additive deposition thick film techniques may be as thin as 3 microns, 5 microns, or 10 microns, or as thick as 20 microns, 50 microns, or 100 microns, or may have a thickness within any range defined between any two of the foregoing values.

Referring to FIG. 5A, further details of the present construction are shown, in which thermal vias 46 are present in openings 48 in insulating layer 42, and circuit layer 44 is deposited over insulating layer 42. Individual LED units 54 may be mechanically and electrically connected as shown in FIG. 5A, in which one portion of each LED unit is attached to thermal via 46 via a solder layer 55 using a metallic solder re-flow or solder bump process with or without additional wire bonding via copper foils, for example. In this manner, thermal vias 46 function to conduct heat directly from the LED units 54 to the substrate material of light module 20 without conductive interference from insulating layer 42. Also, positive and negative connections 57a and 57b of each LED unit 54 may be connected to separate traces 50a and 50b of circuit layer 44 via additional solder layers 55.

Optionally, an overcoat layer 59 (FIGS. 5A and 5B) may be provided directly over circuit layer 44 and/or surrounding layers in order to protect circuit layer 44 and/or surrounding layers from oxidative degradation or other environmental and/or contact damage. The overcoat layer 59 may be an opaque or translucent layer based on heat-cured silicone or epoxy materials, for example, or may be a glass layer for high temperature operation, heat conductivity, and reflectivity.

Advantageously, as best shown in FIGS. 3 and 5A, according the present disclosure, a lighting configuration is provided in an integral manner directly on the exposed metallic deposition surface 40 of light module 20, wherein insulating layer 42 and circuit layer 44 together have a total printed film thickness of as little as 25 microns, 40 microns, or 50 microns, or as great as 100 microns, 150 microns, or 200 microns, or may have a thickness within any range defined between any two of the foregoing values. The LED units 54 themselves provide only a very small incremental additional thickness to the foregoing layered structure, such that the overall thickness of the lighting configuration is minimized. In this manner, the lighting configuration is provided in a pre-assembled manner directly onto light module 20 prior to the point of field installation at which light module 20 is attached to structural support 18 when the ceiling grid system 10 is assembled, thereby easing installation and obviating the need for separate, self-contained LED modules which are mechanically attached to existing ceiling grid components.

Further, as may also be seen from FIGS. 3 and 5A, heat from LED units 54 is conveyed directly from the backside of the dies of the LED units 54 by conduction directly through thermal vias 46, light module 20 and, referring additionally to FIGS. 1 and 2A, into structural support 18 for dissipation within upper space 14 above ceiling grid system 10 to facilitate the efficient removal of heat from the LED units 54 and enhance the more efficient operation of the LED units 54. Thus, the present construction facilitates the use of both low intensity and high intensity LED units with light module 20, depending on the lighting needs of the space being illuminated.

Referring to FIG. 5B a second exemplary light module configuration and thick film application process is shown which, except as described below, has the same configuration and function as that shown in FIG. 5A.

In the embodiment of FIG. 5B, insulating layer 42 is formed as one or several sequentially applied polymer-based dielectrics which include a base polymer such as epoxy, silicone, polyimide, polyester, phenolic, and vinyl, typically provided in a viscous liquid or paste form and including one or more solvents and optionally other additives such as surfactants, stabilizers, dispersants and/or thixotropic agents. The polymer-based dielectric may be applied to deposition surface 40 of light module 20 via known thick film application techniques such as screen printing, for example, followed by curing at a relatively low temperature, which may be as little as 100° C., 125° C. or 150° C., or as high as 250° C., 300° C., or 325° C., or within any range defined between any two of the foregoing temperatures, such as 100° C. to 325° C., 125° C. to 300° C., or 150° C. to 250° C. Typical cure times may range from as little as one half hour to one hour or longer, such as 1.5 hours. Optionally, the curing may be conducted via a two-step cure, such as by using an initial drying or “snap” cure step at a temperature toward a lower end of the foregoing ranges or below, such as room temperature, followed by a full curing step at a temperature toward the upper end of the foregoing ranges. The polymer-based dielectric layer or layers according to this embodiment may be applied to a total thickness of as little as 15 microns, 20 microns, or 20 microns, or as great as 30 microns, 40 microns, or 75 microns, or may have a thickness within any range defined between any two of the foregoing values. Typically, at least two layers will be required for most applications.

Following application of insulating layer 42, circuit layer 44 may be applied to insulating layer 42. In the embodiment of FIG. 5B, circuit layer 44 may be an electrically conductive polymer/metal material including polymeric and metallic components. Exemplary polymers include polyamide and phenolic polymers, for example, as well as epoxy, silicone, polyester, and vinyl, and exemplary conductive metals include silver and copper, for example. The polymer and metallic components are typically provided in a viscous liquid or paste form, including one or more solvents and optionally other additives such as surfactants, stabilizers, dispersants and/or thixotropic agents.

The polymer/metal conductive material may also be applied to deposition surface 40 of light module 20 via known thick film application techniques such as screen printing, for example, followed by curing at a relatively low temperature, which may be as little as 100° C., 125° C. or 150° C., or as high as 250° C., 300° C., or 325° C., or within any range defined between any two of the foregoing temperatures, such as 100° C. to 325° C., 125° C. to 300° C., or 150° C. to 250° C. Typical cure times may range from as little as one half hour to one hour or longer, such as 1.5 hours. The polymer/metal conductive material according to this embodiment may be applied to a total thickness of as little as 5 microns, 10 microns, or 15 microns, or as great as 20 microns, 25 microns, or 30 microns, or may have a thickness within any range defined between any two of the foregoing values.

Advantageously, the polymer/metal conductive material is solderable, meaning that solders may be applied directly to the material for electrical connections. Suitable solders include lead-free solders, such as tin-based solders and bismuth-based solders, for example. Following application of circuit layer 44, LED units 54 are attached as described above in connection with FIG. 5A.

One particular advantage of the configuration shown in FIG. 5B is that each of insulating layer 42 and circuit layer 44 may be applied using conventional thick film techniques such as screen printing, and may also be cured at relatively low temperatures. In particular, in the configuration shown in FIG. 5B, once thermal vias 46 are printed and cured at a relatively high temperature, such as greater than 500° C., all of the remaining steps, including application of insulating layer 42 and circuit layer 44, as well as the soldering of LED units 54 to circuit layer 44, may be conducted at relatively low temperatures, such as below 300° C., in order to conserve energy and cost.

Although the present concept has been described above in connection with ceiling module 12, which is formed as a two-part structure including an elongate structural support 18 and an elongate light module 20, other lighting configurations are possible. For example, in an alternative embodiment, a modular strip construction may be formed, similar to light module 20, including a heat conductive substrate such as aluminum. The modular strip may be formed as a solid or hollow extrusion, or as an elongate strip having a thin profile. The thick film printed layers and LED units described above may be printed directly onto the modular strip in the same manner as described above.

The modular strip may be mounted to new or existing structural components of a building construction, such as beams, trusses, or joists, for example. In this manner, the modular strip may be selectively mounted to any desired location within a building interior, for example, as well as to other locations such as building exteriors or any other support in an environment where lighting is desired. Suitable interior applications include horticultural facilities such as greenhouses, athletic facilities such as indoor stadiums and arenas, performing arts facilities such as theaters, or any other internal spaces. Still further, such modular strips may be mounted exteriorly to building facades to provide exterior perimeter lighting, or to elevated poles to provide street lighting, for example.

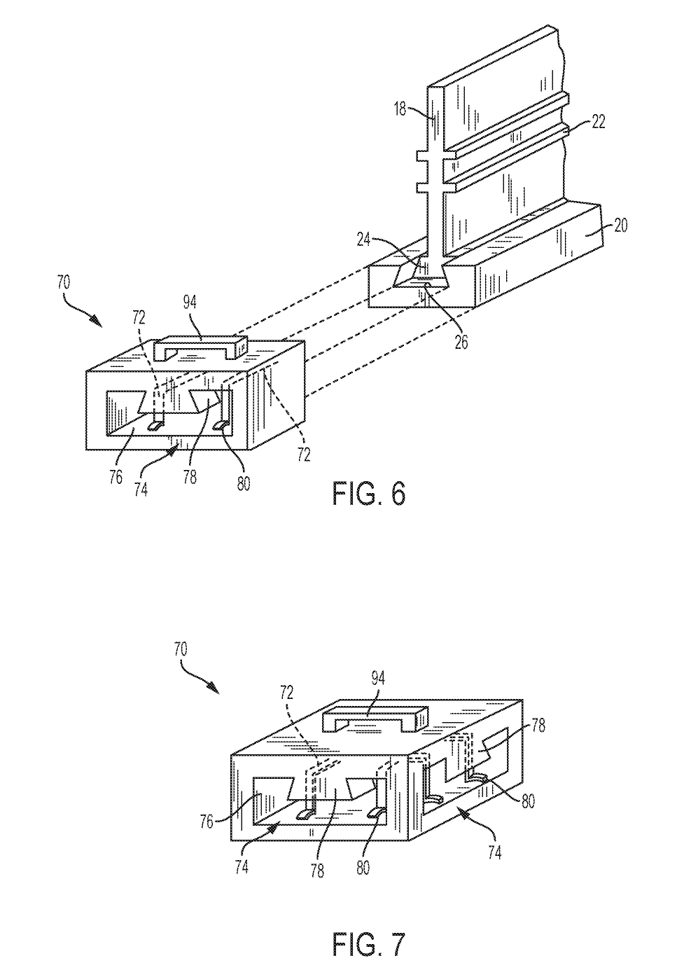

Referring to FIGS. 6 and 7, an exemplary modular connector 70 for connecting two or more ceiling modules 12 is shown. Modular connector 70 may generally be formed of an injection-molded plastic body having an electrically conductive circuit frame 72 embedded therein made of copper or brass, for example, to provide electrical connectivity between two or more connected ceiling modules 12. Circuit frame 72 and its electrical leads are schematically shown in FIGS. 6-8 partially in dashed lines with the understanding that one of ordinary skill in the art would selectively configure the particular design of circuit frame 72 to ensure the proper electrical connections and isolations between the various circuits that may be needed. Connector module 70 includes two or more ports 74 which are shaped to interface with the ends of light modules 20, with ports 74 including, for example, a cavity 76 having an internal projection 78 identical to that of structural support 18 for interfacing with channel 26 of light module 20 via an interference fit, for example. The circuit frames 72 within connector modules 70 may include sets of spring-loaded or other pressure-sensitive or friction responsive electrical contacts 80 for directly engaging circuit traces 50 of circuit layer 44 of light module 20 upon contact of a connector module 70 with a corresponding light module 20.

Connector modules 70 may be configured for in-line connections, in which ports 74 are provided on opposite sides of modules 70, or may include two, three or four ports 74, respectively, on respective sides of modules 70 as shown in FIG. 7 for effecting L-type, T-type, and X-type junctions between three of four ceiling modules 12, respectively. Connector modules 70 also themselves provide mechanical support between the ceiling modules 12.

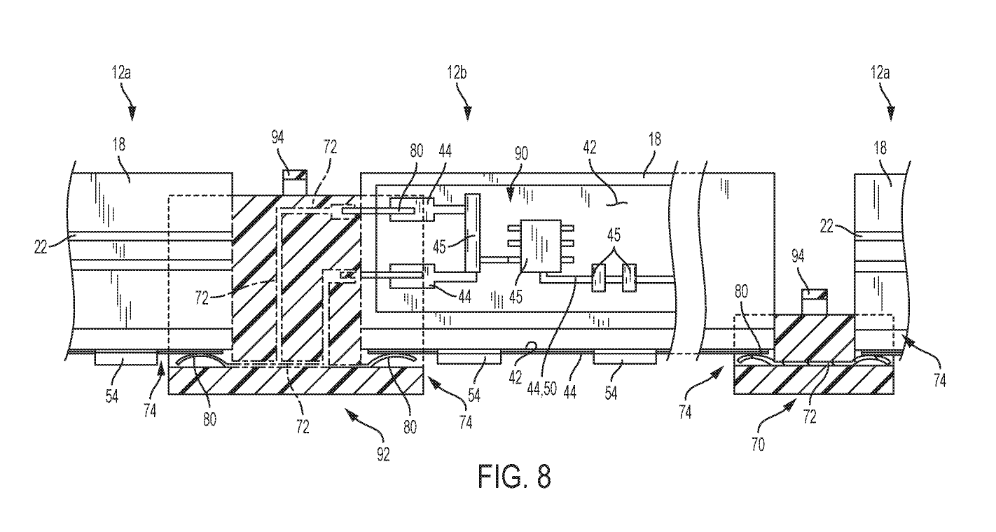

Referring to FIG. 8, an exemplary power supply and electrical in-feed configuration is shown, in which a pair of standard ceiling modules 12a of the type described above are respectively connected to opposite ends of an electrical in-feed ceiling module 12b. Ceiling module 12b may be identical to ceiling module 12a, but additionally includes a power supply circuit 90, which may be a thick film printed layer set as described above, printed directly on the surface of structural support 18 of ceiling module 12 and including an insulating layer 42 and a circuit layer 44 including suitable circuitry, such as circuit traces 50 for connection of electrical components 45 directly to circuit layer 44 via a metallic solder re-flow or solder bump process with or without additional wire bonding via copper foils, for example.

In operation, the power supply circuit 90 receives power from the electrical supply within a building, such as 110 or 220 volts AC current, and steps down the current and/or converts the AC current into DC current as may be needed for powering the LED units 54 of one or more ceiling modules 12a and 12b. Typically, depending on the current supplied and the power requirements of the LED units 54 of ceiling modules 12, an electrical in-feed ceiling module 12b and its power supply circuit 90 may power the electrical in-feed ceiling module 12b itself, together with a series of several standard ceiling modules 12a.

Still referring to FIG. 8, an electrical in-feed connector module 92 may be used to provide power input to LED units 54 of a set of ceiling modules 12 from the power supply circuit 90. In-feed connector module 92 is similar to connector module 70, and may include one or more ports 74, circuit frames 72, and electrical contacts 80. In this manner, electrical power may be transferred from the building or other external supply through power supply circuit 90 and in feed connectors 92 to LED units 54 in a set of light modules 20.

In FIG. 8, on a side of the electrical in-feed ceiling module 12 opposite the electrical in-feed side in which electrical in-feed connector module 92 is shown, a standard connector module 70 is shown for forming a standard electrical and mechanical connection between the electrical in-feed ceiling module 12b and an adjacent standard ceiling module 12a in the manner described above and shown in FIGS. 5 and 6.

Further, in FIGS. 6-8, connector modules 70 and electrical in-feed modules 92 may each include an integrally formed or separately attached connector bar 94 or other suitable structure to accept a ceiling hanger or other hardware, for example, to facilitate mounting to ceiling structure components.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A light module, comprising:
a substrate made of a metallic, heat conductive material, comprising:
a deposition surface;
an electrically insulating layer deposited on said deposition surface;
an electrically conductive circuit layer deposited on said insulating layer and including a plurality of metallic circuit traces; and
a plurality of LED units electrically connected to said circuit layer.

2. The light module of claim 1, wherein said insulating layer and said circuit layer each have a thickness of between 5 and 100 microns.

3. The light module of claim 1, wherein said substrate is formed of a metallic, heat conductive material having a heat conductivity of at least 150 W/m-K.

4. The light module of claim 3, wherein said substrate is formed of aluminum or an aluminum alloy.

5. The light module of claim 1, further comprising at least one thermal via associated with each LED unit, said thermal vias formed of a heat conductive material and extending through respective openings in said insulating layer, said thermal vias in heat conductive contact with said LED units and said deposition surface.

6. A method of manufacturing a light module, comprising the following steps:
providing a substrate made of a metallic, heat conductive material and having an exposed deposition surface;
applying an electrically insulating layer composition onto the deposition surface via a thick film deposition process;
heat curing the electrically insulating layer composition to form an electrically insulating layer;
applying an electrically conductive circuit layer composition on the insulating layer via a thick film deposition process;
heat curing the electrically conductive circuit layer composition to form an electrically conductive circuit layer; and
attaching a plurality of LED units to the circuit layer.

7. The method of claim 6, wherein said applying steps are each performed via screen printing of a paste of particles in a suspension.

8. The method of claim 6, wherein the insulating layer composition includes at least one polymer resin, inorganic particles, a glass phase, and at least one organic solvent.

9. The method of claim 6, wherein the circuit layer composition includes conductive metal particles, at least one polymeric resin, and at least one solvent.

10. The method of claim 6, further comprising the additional step, following said attaching step, of:
attaching the substrate to an elongate structural support made of a heat conductive material.

11. A ceiling grid system including a ceiling module, said ceiling module comprising:
an elongate structural support;
an elongate light module separate from, and removably connectable to, said structural support, said light module made of a metallic, heat conductive material and comprising:
a deposition surface;
an electrically insulating layer deposited on said deposition surface;
an electrically conductive circuit layer deposited on said insulating layer and including a plurality of metallic circuit traces; and
a plurality of LED units attached to said circuit layer.

12. The ceiling grid system of claim 11, wherein said structural support includes a first connector structure in the form of one of a channel and a projection, and said light module includes a second connector structure in the form of the other of said channel and said projection, said projection slidingly received within said channel to removably attach said light module to said structural support.

13. The ceiling grid system of claim 11, wherein said light module further comprises a pair of substantially horizontal shelf surfaces disposed on respective opposite sides of said second connector structure.

14. The ceiling grid system of claim 11, wherein said insulating layer has a thickness of between 5 and 100 microns.

15. The ceiling grid system of claim 11, wherein said circuit layer has a thickness of between 5 and 100 microns.

16. The ceiling grid system of claim 11, further comprising at least one connector module including at least two ports each connectable to a respective end of one of said light modules, said connector module including an insulating body housing a metallic conductor frame.

17. The ceiling grid system of claim 11, wherein said light module has a length between 12 and 48 inches.

18. The ceiling grid system of claim 11, wherein said light module is formed of a metallic, heat conductive material having a heat conductivity of at least 150 W/m-K.

19. The ceiling grid system of claim 11, wherein said light module is formed of aluminum or an aluminum alloy.

20. The ceiling grid system of claim 11, further comprising at least one thermal via associated with each LED unit, said thermal vias formed of a heat conductive material and extending through respective openings in said insulating layer, said thermal vias in heat conductive contact with said LED units and said deposition surface.
